(19) United States
(12) Patent Application Publication
(10) Pub. No.: US 2024/0424523 A1
(43) Pub. Date: Dec. 26, 2024

(54) COATING APPLICATON SYSTEMS AND METHODS OF COATING A SUBSTRATE

(71) Applicant: AXALTA COATING SYSTEMS IP CO., LLC, Wilmington, DE (US)

(72) Inventors: Michael S. Wolfe, Wilmington, DE (US); Jonathan Antal, Philadelphia, PA (US); John R. Moore, Lansdale (PA)

(73) Assignee: AXALTA COATING SYSTEMS IP CO., LLC, Wilmington, DE (US)

(21) Appl. No.: 18/750,702

(22) Filed: Jun. 21, 2024

Related U.S. Application Data
(60) Provisional application No. 63/510,064, filed on Jun. 23, 2023.

(51) Int. Cl. B05C 5/02; B05C 9/06; B05D 1/02

(52) U.S. Cl. CPC B05C 5/027; B05C 5/0208; B05C 9/06; B05D 1/02

(57) ABSTRACT

Coating application systems and methods of using the same are provided. In an exemplary embodiment, a coating application system includes a support system defined in an XYZ coordinate system, where the XYZ coordinate system includes an X axis, a Y axis, and a Z axis that are all perpendicular to each other. The X and Y axes define an XY plane at a zero Z axis position. The support system includes a first and second bar both of which run in the X direction of the XY plane. A traveling rod is connected to the first and second bars and is configured to run in the X direction. A plurality of printheads are connected to the traveling rod, where the plurality of printheads include a first and second printhead that are configured to articulate independent of each other.

### PRIORITY CLAIM

This application claims priority to U.S. Provisional Patent Application Ser. No. 63/510,064 filed on Jun. 23, 2023, which is incorporated herein by reference.

### TECHNICAL FIELD

The technical field generally relates to coating application systems and methods of coating a substrate, and more particularly relates to coating application systems utilizing high transfer efficiency applicators.

### BACKGROUND

Ink jet printing is a non-impact printing process in which a liquid stream of ink (or other liquid coating) is deposited on a substrate. These processes have the advantage of allowing digital printing of the substrate, which can be easily tailored to different individual requirements. The stream of ink can be jetted onto the substrate by a variety of jet application methods, including a continuous liquid stream, drop-on-demand printing, and other techniques. The liquid coating is typically jetted from a high transfer efficiency applicator that is positioned in a printhead.

Conventional inkjet coatings typically have been formulated to print on porous substrates such as paper and textiles, where the ink is rapidly absorbed into the substrate to facilitating drying and handling shortly after printing. However, other applications are developing, such as jet printing of coatings for automobiles or other vehicles, as well as a wide variety of other substrates. Automotive coatings have durability requirements that are far greater in terms of physical durability, corrosion protection, longevity, etc. than that of papers or fabrics, as well as appearance requirements. Therefore, jet printing of automobiles typically utilizes different types of jet coatings than for papers, fabrics, and other substrates. Other specialized coatings may be utilized for other applications, such as wood substrates, plastic substrates, etc.

In the automotive industry, a vehicle body is typically covered with a series of finishes including, for example, an electrocoat, a primer, a colored basecoat providing the color, and a clear topcoat to provide addition protection and an attractive finish. Currently, most automobile bodies are painted with the basecoat being applied in a spray operation where the paint droplets contact the substrate as an aerosol. The coating is applied with pneumatic spray or rotary equipment producing a broad jet of paint droplets with a wide droplet size distribution. This has the advantage of producing a uniform high-quality coating in a relatively short time by an automated process. However, if a vehicle is to be coated with multiple colors, masking and multiple paint application processes are required. Furthermore, aerosol coating application usually results in some loss of the coating product from overspray and other factors.

Jet printing often involves applying coatings from one or more high transfer efficiency applicators within a printhead, and the printhead is sequentially passed over adjacent sections of the substrate during the coating process. Jet printing of automotive surfaces often produces visible defects at the overlap or valley between successive jet printing passes. As such, stripe overlap or stripe valley is a predominant defect in digital printing applications. This problem is exacerbated with poor precision of mechanical indexing and flashing of a previous stripe before the proceeding stripe is applied. The slight overlap or valley between different passes of a high transfer efficiency applicator in the printhead often produces a varying coating layer thickness that is visible to the human eye.

Accordingly, devices and methods of jet printing automotive components, or other substrates, that does not produce visible variations at the interface of different printing passes are desired. Furthermore, devices and methods for the uniform painting of an automobile or other substrate using a high transfer efficiency applicator are desirable. Furthermore, other desirable features and characteristics will become apparent from the subsequent detailed description and the appended claims, taken in conjunction with this background.

### BRIEF SUMMARY

Coating application systems and methods of using the same are provided. In an exemplary embodiment, a coating application system includes a support system defined in an XYZ coordinate system, where the XYZ coordinate system includes an X axis, a Y axis, and a Z axis that are all perpendicular to each other. The X and Y axes define an XY plane at a zero Z axis position. The support system includes a first and second bar both of which run in the X direction of the XY plane. A traveling rod is connected to the first and second bars and is configured to move in the X direction. A plurality of printheads are connected to the traveling rod, where the plurality of printheads include a first and second printhead that are configured to articulate independent of each other.

A method of coating a substrate is provided in another embodiment. The method includes positioning the substrate on a substrate support of a coating application system, where the substrate has a substrate maximum Y length and a substrate maximum X length, as determined by an XYZ coordinate system. The substrate also has a substrate surface. A plurality of printheads are supported on a traveling rod, where the plurality of printheads include a first and second printhead, and where each printhead includes a high transfer efficiency applicator. The first and second printheads are configured to articulate independent of each other, and the first and second printheads are at different Y positions on the traveling rod. The traveling rod has a traveling rod Y length that is greater than the substrate maximum Y length. The traveling rod is moved over the substrate such that the plurality of printheads pass over the entire substrate surface, and a coating is sprayed from the high transfer efficiency applicators onto the entire substrate surface as the traveling rod moves. The first and second printheads are articulated independent of each other as the coating is sprayed onto the substrate surface, where the first and second printheads are articulated to be about perpendicular to the substrate surface as the coating is sprayed.

Another coating application system is provided in another embodiment. The coating application system includes a support system defined in an XYZ coordinate system that has an X axis, a Y axis, and a Z axis that are all perpendicular to each other. The X and Y axes define an XY plane at a zero Z axis position. The support system includes a first and second bar that both run in the X direction of the XY plane. A traveling rod is connected to the first and second bars, where the traveling rod is configured to travel in the X direction. A plurality of printheads are connected to the traveling rod, where the plurality of printheads include a first and second printhead. A substrate support is configured to support a substrate having a substrate maximum X length, a substrate maximum Y length, and a substrate surface. The traveling rod has a traveling rod Y length that is greater than the substrate maximum Y length, and the first and second bars have a first and second bar length, respectively, where both the first and second bar lengths are greater than the substrate maximum X length. A first adjustable support connects the first printhead to the traveling rod, where the first adjustable support is configured to vary a first printhead Z position. A second adjustable support connects the second printhead to the traveling rod, where the second adjustable support is configured to vary a second printhead Z position independent of the first printhead.

### BRIEF DESCRIPTION OF THE DRAWINGS

The present disclosure will hereinafter be described in conjunction with the following drawing figures, wherein like numerals denote like elements, and wherein:

FIG. 1 is a perspective view of an embodiment of a substrate to be coated;

FIG. 2 is a top view of an embodiment of a substrate to be coated;

FIG. 3 is a perspective view of an embodiment of a coating application system, where the first bar is partially removed to provide better clarity of the coating application system embodiment;

FIG. 4 is a sectioned side view of an embodiment of a coating application system;

FIG. 5 is a front view of an embodiment of a coating application system; and

FIG. 6 is a bottom view of an embodiment of a traveling rod of the coating application system.

### DETAILED DESCRIPTION

The following detailed description is merely exemplary in nature and is not intended to limit the application or uses of the embodiment described. Furthermore, there is no intention to be bound by any theory presented in the preceding technical field, background, brief summary, or the following detailed description.

A coating application system provides a complete coating of a substrate surface in a single coating pass. A gantry-type support is provided for a plurality of printheads, where each printhead includes one or more high transfer efficiency applicators. The printheads are attached to a traveling rod, where the traveling rod starts on one end of the substrate to be coated and passes across the substrate during the coating operation. The coating application system includes enough printheads affixed to the traveling rod to span the entire width of the substrate to be coated, so the entire substrate is coated in a single coating pass. High transfer efficiency applicators are preferrable positioned about perpendicular to the substrate surface at a set print distance for optimal performance, but the substrate surface may not be flat. For example the substrate surface may have curves, undulations, mounds, or other surface features for appearance, acrodynamics, venting, or other purposes. Therefore, at least some of the printheads articulate during the printing process such that the high transfer efficiency applicators remain about perpendicular to the substrate surface throughout the printing process, even at positions where the substrate surface is not parallel with the path of the traveling rod. Furthermore, the printheads may be attached to the traveling rod with an adjustable support, such that the adjustable support can move the printhead up and down during the printing process so the print distance remains within a specified range throughout the printing process. Because the substrate surface may vary in geometry, at least some of the printheads can articulate independent of one another, and at least some of the printheads can adjust the print distance independent of one another during the printing process.

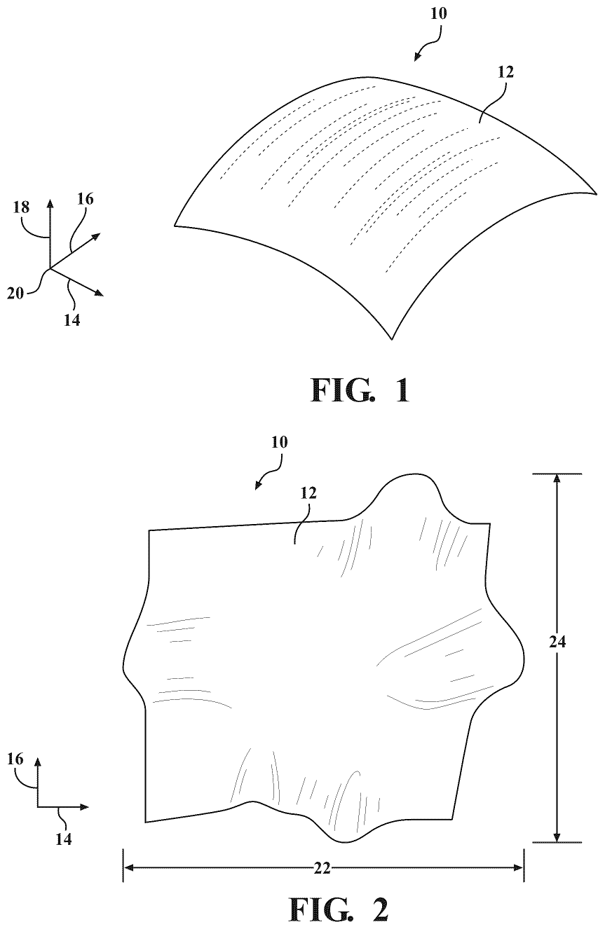

Referring to FIGS. 1 and 2, a substrate 10 has a substrate surface 12 that is to be coated. The substrate 10 may be a component of a motor vehicle, such as a fender, a hood, a roof, a bumper, or other component in some embodiments. However, in other embodiments, the substrate 10 may be other articles, such as a wagon, a satellite dish, or just about anything else. In an exemplary embodiment, the substrate 10 is a motor vehicle body part, and the substrate 10 has been coated with a primer and optionally an electrocoat. As such, the substrate surface 12 to be coated may be the surface of the primer on the base substrate 10. The substrate 10 may be metallic in some embodiments, but the substrate 10 may also be polymeric, wooden, clay, or just about any other solid material in various embodiments. The substrate 10 may also be glass in some embodiments, where glass is not considered a “solid” in some instances, so the substrate 10 is most anything that presents a fixed substrate surface 12 that can be coated.

The substrate 10 may have a curved substrate surface 12, as indicated by the shading in FIG. 1. For reference, the substrate is defined in a 3-dimensional XYZ coordinate system, where each of the X axis 14, the Y axis 16, and the Z axis 18 are perpendicular to each other. The plane formed by the X and Y axes 14, 16 is referred to as the XY plane, and is generally considered to be horizontal. However, it is possible for the XY plane to be vertical, horizontal, or any other angle, as long as the X, Y, and Z axes 14, 16, 18 are all perpendicular to each other and can be used to identify any point in space. As such, a point in space is defined by each of an X value, a Y value, and a Z value, where the X, Y, and Z values indicate a distance along the respective axes from an origin 20, where the X, Y, and Z values at the origin 20 are zero. The X, Y, and Z coordinate system, or the cartesian coordinate system, is well known.

The substrate 10 has a substrate maximum X length 22, a substrate maximum Y length 24, and a substrate maximum Z length, where these maximum lengths are the longest dimension of the substrate 10 in each of the X, Y, and Z axes 14, 16, 18, respectively. Each point on the substrate 10 (or on the substrate surface 12) can be identified by an X, Y and Z value for the distance from the origin in each of the X axis 14, Y axis 16, and Z axis 18 directions. The X, Y and/or Z value for any point on the substrate can be a negative value. For example, if the substrate 10 is positioned below a reference XY plane, the Z direction values of the substrate surface would be negative, or less than zero.

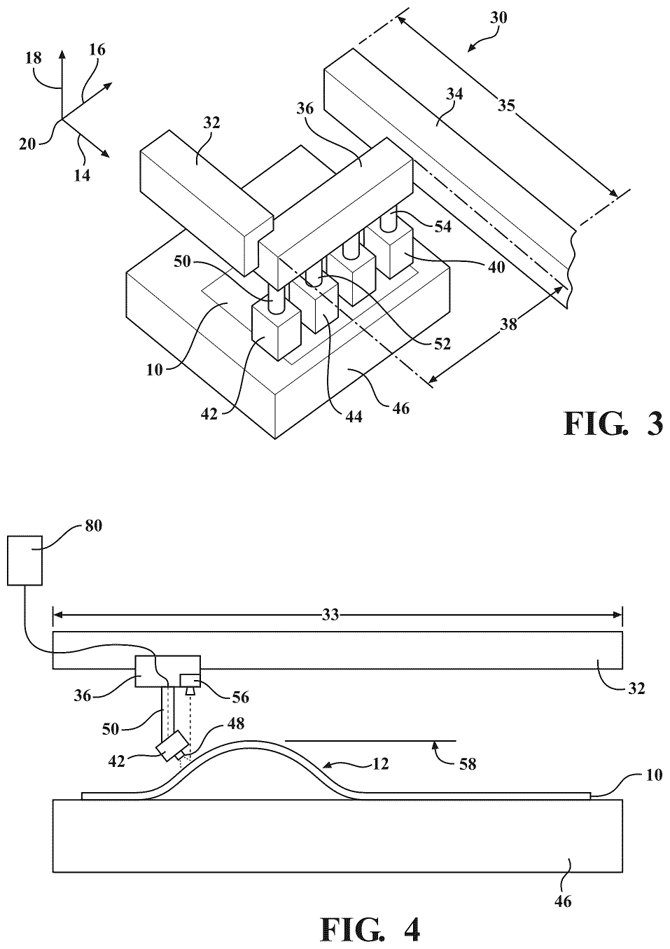

A partial perspective view of an embodiment of a coating application system 30 is illustrated in FIG. 3, with further reference to FIG. 4. The coating application system 30 includes a first bar 32 and a second bar 34, where the first bar 32 is sectioned to facilitate viewing of the other components. The first and second bars 32, 34 are positioned in the XY plane, and run in the X direction at a zero point along the Z axis 18, or at a zero Z axis position. The first and second bars 32, 34 form a type of gantry system, where a travelling rod 36 is moveably connected to the first and second bars 32, 34. As such, the traveling rod 36 extends along the Y direction, and moves in the X direction along the length of the first and second bars 32, 34. The traveling rod 36 may be connected to the first and second bars 32, 34 in a wide variety of manners that allow for movement along the length of the first and second bars 32, 34 (i.e., movement in the X direction.) For example, the first and second bars 32, 34 may be round, and the traveling rod 36 may be connected by a clamp or bearing extending around the first and second bars 32, 34. A separate drive shaft (not illustrated) could then be used for motive force of the traveling rod 36. Alternatively, the first and second bars 32, 34 could include gears or teeth (not illustrated), with matching gears or teeth (not illustrated) in the traveling rod 36, and a motor could active the gears in the traveling rod 36 or in the first and/or second bars 32, 34 for motive force. In another embodiment, an air cushion could support the traveling rod 36 on the first and second bars 32, 34, such that the traveling rod 36 does not physically touch the first and second bars 32, 34 but is still connected by the air cushion. A wide variety of other connection systems and drive mechanisms could be used in various embodiments.

The traveling rod 36 is illustrated as a single structure, but it is possible in some embodiments for the traveling rod 36 to include more than a single piece. In embodiments where the traveling rod 36 has more than one piece, the different pieces may be connected such that the pieces of the traveling rod 36 move at the same speed and in the same direction.

A plurality of printheads 40 are connected to the traveling rod 36, where the plurality of printheads 40 includes a first printhead 42 and a second printhead 44. Each of the plurality of printheads 40 includes one or more high transfer efficiency applicators 48 (illustrated in FIG. 4), where the coating material is ejected from the high transfer efficiency applicators 48. Each of the plurality of printheads 40 may include the same number of high transfer efficiency applicators 48 in an exemplary embodiment, but the number of high transfer efficiency applicators 48 per printhead may vary within a single coating application system 30.

The high transfer efficiency applicator 48 is used for ejecting the coating onto the substrate 10. The coating is ejected from one or more nozzles in an engineered/controlled fashion that creates a fine stream, that may or may not break up into droplets. The fluid stream is targeted to the substrate 10 such that the jet or drops arrive at specific locations to form a continuous film or pattern on the substrate 10. In an alternate embodiment, the high transfer efficiency applicator 48 may be configured to apply a plurality of dots or droplets of the coating on the substrate, where the eye tends to combine the dots to produce a desired visual effect. The continuous coating described above provides more protection from the environment than the droplets, which is more desirable in some embodiments. As a result, there is essentially no overspray (drops missing their target) and nearly 100% transfer efficiency (essentially all coating goes to targeted location). In an exemplary embodiment, the transfer efficiency of the coating that ends up deposited on the substrate 10 is 99.9% or greater. Some allowance should be made for start-up and stopping the high transfer efficiency applicator 48. Devices of this type have been referred to as drop-on-demand, stream-on demand, overspray-free, or ultra-high transfer efficiency applicators. The high transfer efficiency applicator 48 stands apart from spray atomization techniques where energy, such as pneumatic, hydraulic, or centrifugal energy, is introduced to create a partially controlled, random distribution of droplet sizes, trajectories, and speeds. Some additional mechanism (electrostatics and or shaping air) may optionally further guide the coating to the substrate 10. In the case of paint spray, there is always some overspray and transfer efficiency loss.

In one embodiment, the high transfer efficiency applicator 48 includes a nozzle that defines a nozzle orifice and may have a nozzle diameter of from about 0.00002 meters (m) to about 0.0004 m. In another embodiment, the high transfer efficiency applicator 48 may be fluidly connected to a reservoir (not illustrated) configured to contain a coating composition. For example, the high transfer efficiency applicator 48 may be configured to receive the coating composition from the reservoir and configured to expel the coating composition through the nozzle orifice to the substrate 10 to form a coating layer. The high transfer efficiency applicator 48 may be configured to expel the coating composition through the nozzle orifice at an impact velocity of from about 0.2 meters per second (m/s) to about 20 m/s. Alternatively, the high transfer efficiency applicator 48 may be configured to expel the coating composition through the nozzle orifice at an impact velocity of from about 0.4 m/s to about 10 m/s, or alternatively at a value outside these ranges.

The high transfer efficiency applicator 48 itself may be any type known in the art. For example, in various embodiments, the high transfer efficiency applicator 48 is as described in one or more of patent or publication numbers US2004/0217202A1, US2009/0304936A1, US2020/0070182A1, U.S. Pat. No. 7,824,015B2, U.S. Pat. No. 8,091,987B2, or U.S. Pat. No. 11,117,160B2, each of which are expressly incorporated herein in their entirety for use in various non-limiting embodiments. The high transfer efficiency applicator 48 may be mounted in a printhead.

The substrate 10 is positioned on a substrate support 46. The first and second bars 32, 34 are positioned in the XY plane defined at a zero value in the Z direction. In an exemplary embodiment, the substrate support 46, and the substrate 10 on the substrate support 46, are positioned below the XY plane so the Z value for the entire substrate 10 and substrate support 46 have negative values. In alternate embodiments, it is possible for the travelling rod 36 to be positioned and travel in a different XY plane than the first and second bars 32, 34, so it is possible for at lease some of the substrate 10 and/or the substrate support 46 to be positioned at a point above the first and second bars 32, 34 such that the Z value at a point on the substrate 10 and/or the substrate surface 12 could be positive.

The traveling rod 36 has a traveling rod Y length 38 that is greater than the substrate maximum Y length, so the coating application system 30 can cover the entire Y length (i.e. width) of the substrate in a single pass. The first bar 32 has a first bar length 33 (illustrated in FIG. 4) that is greater than the substrate maximum X length, and the second bar 34 has a second bar length 35 that is greater than the substrate maximum X length 22. The first bar length 33 and the second bar length 35 may be the same in an exemplary embodiment, but it also possible for these lengths to be different from each other. Because the first and second bar lengths 33, 35 are greater than the substrate maximum X length 22, the coating application system 30 can be configured to coat the entire X length of the substrate 10 (i.e., the length) in a single pass. As such, the entire substrate surface 12 can be coated in a single pass of the coating application system 30. This eliminates the overlap or valley between successive passes from a printhead, because there are no successive printhead passes. Adjacent printheads produce a coating layer that may have some flow at the time of application, so the coating from adjacent printheads can meld and combine without leaving a visible valley or overlap area on the substrate 10.

The first printhead 42 and the second printhead 44 are configured to articulate independent of each other, such that the first printhead 42 and the second printhead 44 can move in different directions at the same time, where the motion is relative to the traveling rod 36. The first and second printheads 42, 44 (and any other printheads that may independently articulate) may be connected to the traveling rod 36 with a connection that facilitates movement (relative to the traveling rod 36) in the X direction, or in the Y direction, or in both the X and Y directions at the same time. For example, the connection may be a ball and socket type connection, where movement is possible in any direction within the XY plane. Alternatively, a flexible connection may be used that allows for movement in the X and/or Y directions, or a set of gears may be used.

The motive force for the movement of the first and second printheads 42, 44 may be provided in a wide variety of manners. For example, small servos or other motors may be utilized. Alternatively, pneumatic or hydraulic mechanisms could be used for movement and articulation of the first and second printheads 42, 44. Other possible techniques may also be utilized in various embodiments. The independent articulation of the first and second printheads 42, 44 may extend to other printheads of the plurality of printheads 40. In an exemplary embodiment, all of the plurality of printheads 40 can articulate independently of all the other of the plurality of printheads 40, such that each of the printheads can be individually articulated independent of any other printhead.

Each of the plurality of printheads 40 may be articulated such that the high transfer efficiency applicator 48 is positioned about perpendicular to the substrate surface 12 at the point on the substrate surface 12 where coating material is applied by the high transfer efficiency applicator(s) 48 for each printhead. For example, the first and second printheads 42, 44 may articulate to position the high transfer efficiency applicator(s) positioned thereon within about +/−1 degree from perpendicular to the substrate surface 12 at the point of application of the coating by that printhead. In an alternate embodiment, first and second printheads 42, 44 may articulate for coating application within about +/−2 degrees of perpendicular, or +/−5 degrees of perpendicular, or +/−10 degrees of perpendicular, or within other specified ranges in various embodiments.

In some embodiments, one or more of the plurality of printheads 40 may span an area of the substrate 10 that includes corrugations or other surface changes, so the printhead 40 may be about perpendicular to some points of the substrate 10 but may not be about perpendicular to other areas of the substrate 10 within the area where coating is applied by the single printhead 40. As such, the areas of the substrate 10 that are corrugated or otherwise have varying surface topography may not be perpendicular to the printhead, while other areas of the substrate 10 are. Large changes in the slope of the substrate 10 do remain about perpendicular to the substrate 10, so “perpendicular” to the substrate 10 means perpendicular to an average of the surface area over which any individual printhead passes.

A side view of an embodiment of a coating application system is shown in FIG. 4, with continuing reference to FIG. 3. The substrate 10 has a substrate maximum Z position 58 that is less than the zero Z position, where the zero Z position is at a center axis of the first bar 32. As such, the traveling rod 36 and the attached plurality of printheads 40 may be configured to pass over the substrate 10 during the coating application. As mentioned earlier, the XY plane may not be horizontal in some embodiments, so reference to passing “over” the substrate 10 is meant to include the plurality of printheads 40 all passing along one side, or one substrate surface 12. The first printhead 42 is connected to the travelling rod 36 by a first adjustable support 50, where the first adjustable support 50 is configured to vary and adjust a first printhead Z position by moving the first printhead 42 up or down (relative to the traveling rod 36) to adjust to changes in the height (i.e., the first printhead Z position) of the point at which the first printhead 42 is applying the coating to the substrate surface 12. The first printhead 42 moves up and down in a direction parallel to the Z axis 18 in an exemplary embodiment, but the first adjustable support 50 may move the first printhead 42 in a direction that is not exactly parallel to the Z axis 18 in some embodiments. In a similar manner, the second printhead 44 is connected to the traveling rod 36 with a second adjustable support 52, and the remaining plurality of printheads 40 may be connected to the traveling rod 36 with a plurality of adjustable supports 54. The second printhead Z position and optionally one or more of the remaining plurality of printhead Z positions are adjusted such that the print distance for each printhead is within the desired specification.

The plurality of adjustable supports 54 may be adjusted such that a print distance, which is the distance from the high transfer efficiency applicator 48 to the substrate surface 12 at the point of coating application, is in a range of about 0.1 to about 3 centimeters. However, in alternate embodiments, the plurality of adjustable supports 54 may be utilized to maintain the position of the plurality of printheads 40 at a print distance of from about 0.2 to about 2.5 centimeters, or from about 0.5 to about 2.5 centimeters, or from 1.5 to about 2.5 centimeters throughout the coating application process in various embodiments. In embodiments where the substrate 10 has corrugations or other surface changes within the area covered by a single printhead, the printhead should be positioned such that all areas are within the print distance range mentioned above.

The quantity of coating material applied per unit time may be adjusted to account for the articulation of any of the plurality of printheads 40 in an exemplary embodiment. For example, if the substrate surface 12 is angled such that the first printhead 42 is significantly angled to remain about perpendicular to the substrate surface 12 at the point of application, the first printhead 42 may be configured to increase the amount of coating material applied because the angled substrate surface 12 presents more total surface area than a flat substrate surface 12. However, in alternate embodiments the plurality of printheads 40 may be configured to apply the same amount of coating per unit time regardless of the angle of the substrate surface 12, and consequently regardless of the degree to which the printhead is articulated.

FIG. 4 illustrates a Z length detector 56 that may be utilized to determine the distance between the traveling rod 36 (or any other convenient reference point) to the substrate surface 12 at a point below any particular printhead. The Z length detector 56 may utilize light detection and ranging (LIDAR), sonic testing, a feeler rod, or other techniques for determining the distance to the substrate surface 12. The Z length detector 56 may include a plurality of Z length detectors, where each of the plurality of printheads 40 has a separate Z length detector 56. However, in alternate embodiments a single Z length detector 56 may be utilized, or a plurality of Z length detectors 56 may be utilized where each Z length detector 56 determines the distance to the substrate surface 12 for a portion of the substrate 10. Other techniques may also be utilized.

The Z length detector 56 is connected to the coating application system 30 in a position over the substrate support 46. In an exemplary embodiment, the Z length detector 56 is positioned on one or more printheads, as illustrated in FIG. 4, but the Z length detector 56 could also be positioned on a separate mounting position in alternate embodiments. For example, the Z length detector 56 could be mounted on a separate traveling rod (not illustrated), where the Z length detector 56 moves across the substrate 10 in front of the traveling rod 36 that the plurality of printheads 40 are connected to. The Z length detector 56 may move back and forth on the separate traveling rod (not illustrated), or a plurality of Z length detectors 56 may be used, or a single position on the separate traveling rod (not illustrated) may suffice to determine the distance to the substrate surface at all relevant points. Alternate embodiments for the Z length detector 56 may also be utilized.

In an alternate embodiment, the coating application system 30 has a substrate map (not illustrated), where the Z position of the substrate surface 12 is saved in a memory device for positioning the plurality of printheads 40 in the Z direction. As such, the substrate map includes a substrate Z position at a plurality of XY coordinate points. The substrate map (not illustrated) would be customized for each substrate, so if different types of components were being coating the appropriate substrate map would be used.

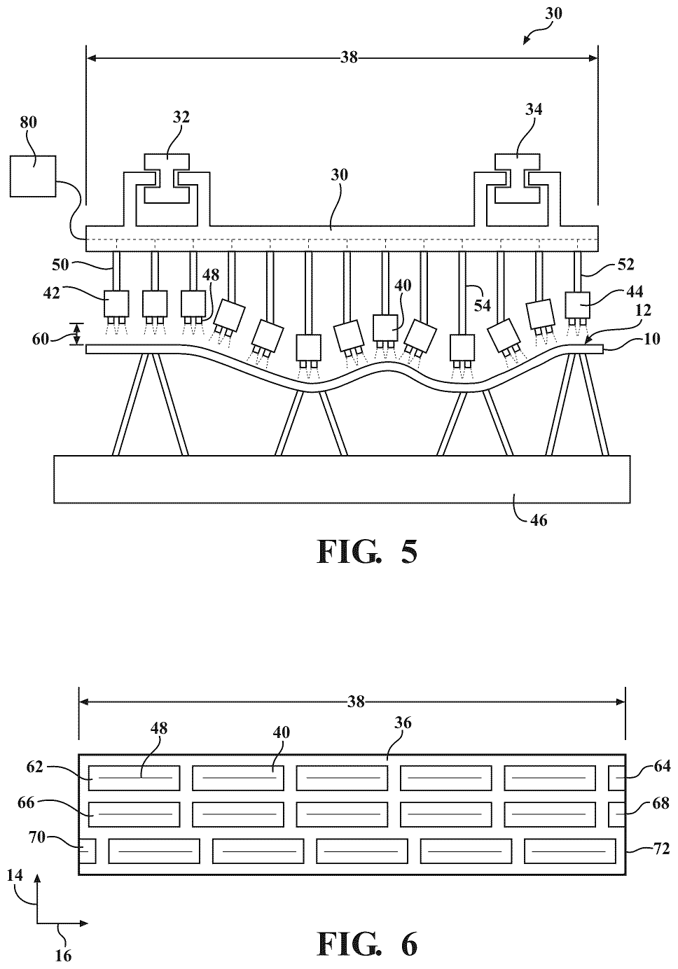

Referring to FIG. 5, with continuing reference to FIGS. 3 and 4, the substrate support 46 is shown with stands for supporting the substrate 10 in position for coating, where the stands are part of the substrate support 46. The travelling rod 36 is positioned below the first and second bars 32, 23, and the plurality of adjustable supports 54 are shown extending the plurality of printheads 40 to within the print distance 60 of the substrate surface 12. The plurality of printheads 40 are shown articulating to remain about perpendicular to the substrate surface 12 at the point of coating application by each of the plurality of printheads 40.

The traveling rod 36 may include one or more rows of printheads, as illustrated in FIG. 6, with continuing reference to FIGS. 3-5. FIG. 6 is a bottom view of the traveling rod 36. In the embodiment illustrated in FIG. 6, there are 3 rows of printheads, including a first row 62 at a first X position 64, a second row 66 at a second X position 68, and a third row 70 at a third X position 72. The first, second and third X positions are all different, and have different positions on the X axis at any one time. The different rows 62, 66, 70 of printheads may be configured to apply different coatings in an exemplary embodiment. For example, the first row 62 at the first X position 64 may apply a first coating onto the substrate surface 12; the second row 66 at the second X position 68 may apply a second coating onto the substrate surface 12; and the third row 70 at the third X position 72 may apply a third coating onto the substrate surface 12. In some embodiments with different rows 62, 66, 70 of printheads 40, the printheads 40 in a row along the Y axis 16 may be staggered in the X direction relative to the printheads 40 in a different row along the Y axis 16, such that the printing from one of the rows (for example, the third row 70) covers gaps that may be present from a previous row (for example, the second row 66 as illustrated in FIG. 6). This type of arrangement with the printheads 40 for rows at one Y position being staggered along the X direction relative to another row at a different Y position may provide for a more complete and cleaner coating, as illustrated for the second and third rows 66, 70 in FIG. 6.

The first, second, and third coatings may all be different from each other, and the coating application system may include more or less than 3 rows of printheads. For example, they different coatings may be different colors, so a detailed color image could be printed in a single pass. The number of rows of printheads could be expanded to include as many colors as needed for the colored image. Alternatively, the different coatings could provide different types of coatings, such as a color coat and then a clearcoat. In yet another embodiment, the different types of coatings may provide superior protection for the substrate, such as by the use of different coatings with different types of binders. Other types of coating combinations are also possible.

The coating application system 30 may include one or more controller(s) 80, as illustrated in FIGS. 4 and 5. The controller 80 is in communication with the first and second printheads 42, 44, and may be in communication with the first and second adjustable supports 50, 52. The controller is configured to control the articulation of the first and second printheads 42, 44 independently of each other, and may be configured to control the articulation of up to all of the plurality of printheads 40 independently of each other. In a similar manner, the controller 80 (or a different controller 80) may be configured to control extension of the first and second adjustable supports 50, 52, and thereby to control the first printhead Z position and the second printhead Z position independently of each other. As such, the controller may be configured to maintain the print distance for the first and second printheads 42, 44 within the set specification, as discussed above. The controller 80 may be in communication with more than just the first and second printheads 42, 44 and the first and second adjustable supports 50, 52, such that the articulation and Z direction adjustments for up to all of the plurality of printheads 40 may be independently controlled by the controller.

The controller 80 may include a computer, a memory, a processing unit, or other devices capable of issuing commands to devices. In an exemplary embodiment, the controller 80 receives input, such as the substrate Z position and the substrate surface topography, and issues commands to control the position of the first and second printheads 42, 44, as discussed above. The controller 80 may include a memory that is tangible and non-transitory, as well as associated components. For example, the controller 80 may include an input device such as a keyboard and/or a mouse, and electronic communication devices such as a modem, etc. The controller 80 may be a plurality of processing devices in various embodiments. In embodiments that include a Z length detector 56, the Z length detector 56 sends the Z position of the substrate surface 12 at the desired application point, and the controller 80 utilizes the Z position of the substrate surface 12 for adjusting the Z position of the appropriate printheads. Alternatively, the substrate map may be saved in the memory of the controller and referenced for controlling the position and angle of the appropriate printheads.

A wide variety of coating compositions may be utilized in the coating application system 30. A coating composition is selected to be suitable for use in the method provided, and for the substrate 10. The coating composition is particularly suitable for overspray-free applications and provides good appearance via suitable flow and levelling, while maintaining low sag under the conditions described. The coating composition is formulated as a fluid suitable for the jetting requirements of high transfer efficiency applicators 48.

The coating composition includes a binder, which may be present in an amount of from about 15 to about 70 wt. %, based on the total weight of the coating composition. In various embodiments, the binder is present in an amount of from about 20 to about 65 wt. %, for example, from about 25 to about 60 wt. %, such as from about 30 to about 55 wt. %. In other embodiment, the binder is present in an amount of from about 40 to about 50 wt. %, for example, from about 45 to about 50 wt. %, where the wt. % mentioned above is based on the total weight of the coating composition. The term “binder” refers to film forming constituents of the coating composition. The binder can include polymers, oligomers, or a combination thereof that are used for forming a coating composition having desired properties, such as hardness, protection, adhesion, and others. In various embodiments, the binder includes polymers that may crosslink during the cure. Exemplary binders suitable for use in the coating composition include, but are not limited to, polyurethane polymers; polyester polymers; latex polymers; acrylic and/or methacrylic polymers; epoxy polymers, melamine polymers; a polymer that has a crosslinkable-functional group, such as an isocyanate-reactive group, where the polymers may be homopolymers or copolymers. Binders that crosslink on curing typically include a crosslinkable component and a crosslinking component, but binders may crosslink functional groups on a single type of polymer. The binder may also cure upon exposure to ultraviolet light, electron beams, or other sources of energy.

As described in further detail below, the coating composition is not particularly limited in form ahead of application. The coating composition may be formulated and used as a one-component (i.e., “1K”) composition. Alternatively, the coating composition may be a two-component (i.e., “2K”) composition. It is even possible to utilize coating compositions with more than 2 components. The coating composition may be a water-borne composition, or a solvent-borne composition. In specific embodiments, however, the coating composition is a 1K solvent-borne composition. In an exemplary embodiment of a 1K coating composition, the composition may include an acrylic binder, a polyester binder, or combinations thereof; a melamine cross-linker; an optional pigment; an organic solvent; and a polyamide wax, sag control and/or rheology control agents, as well as other additives may also be included, such as antioxidants, surfactants, etc. In an exemplary embodiment of a 2K coating composition, the composition includes a hydroxyl-functional resin; an isocyanate cross-linker; an optional pigment; an organic solvent; as well as other additives that may also be included, such as antioxidants, surfactants, etc. Many other types of coatings or coating compositions may also be utilized in various embodiments. The type of coating can be customized to the desired use and effects, as understood by those skilled in the art.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration in any way. Rather, the foregoing detailed description will provide those skilled in the art with a convenient road map for implementing an exemplary embodiment. It being understood that various changes may be made in the function and arrangement of elements described in an exemplary embodiment without departing from the scope as set forth in the appended claims.

What is claimed is:

1. A coating application system comprising:
a support system defined in an XYZ coordinate system, wherein the XYZ coordinate system comprises an X axis, a Y axis, and a Z axis that are all perpendicular to each other, wherein the X axis and the Y axis define an XY plane, wherein the XY plane is at a zero Z axis position, wherein the support system comprises a first bar and a second bar both running in an X direction in the XY plane;
a traveling rod connected to the first bar and the second bar, wherein the traveling rod is configured to travel in the X direction; and
a plurality of printheads connected to the traveling rod, wherein the plurality of printheads comprises a first printhead and a second printhead, wherein the first printhead and the second printhead are configured to articulate independent of each other.

2. The coating application system of claim 1, further comprising:
a substrate support configured to support a substrate having a substrate maximum X length and a substrate maximum Y length, wherein the traveling rod has a traveling rod Y length that is greater than the substrate maximum Y length, wherein the first bar has a first bar X length and the second bar has a second bar X length, wherein the first bar X length and the second bar X length are both greater than the substrate maximum X length.

3. The coating application system of claim 2, wherein:
the substrate support is configured to support the substrate such that a substrate maximum Z position is less than the zero Z axis position.

4. The coating application system of claim 2, wherein:
the plurality of printheads are configured to provide a continuous coating of the substrate over the substrate maximum X length and the substrate maximum Y length in a single pass.

5. The coating application system of claim 2, wherein:
the plurality of printheads comprise a first row of printheads at a first X position and a second row of printheads at a second X position, wherein the first X position and the second X position have different positions in the X direction at any one time.

6. The coating application system of claim 5, wherein:
the first row of printheads is configured to apply a first coating onto a substrate surface; and
the second row of printheads is configured to apply a second coating onto the substrate surface, wherein the second coating is different than the first coating.

7. The coating application system of claim 2, further comprising:
a Z length detector connected to the coating application system in a position over the substrate support, wherein the Z length detector is configured to determine a Z position of a substrate surface at an XY coordinate point.

8. The coating application system of claim 1, further comprising:
a controller in communication with the first printhead and the with the second printhead, wherein the controller is configured to control the articulation of the first printhead and the articulation of the second printhead such that the first printhead and the second printhead are about perpendicular to a substrate surface as the first printhead and the second printhead pass over the substrate surface.

9. The coating application system of claim 8, wherein:
the controller comprises a memory configured to store a substrate map, wherein the substrate map comprises a substrate Z position at a plurality of XY coordinate points.

10. The coating application system of claim 1, wherein:
the first printhead is connected to the traveling rod through a first adjustable support, the second printhead is connected to the traveling rod through a second adjustable support, wherein the first adjustable support is configured to vary a first printhead Z position, and the second adjustable support is configured to vary a second printhead Z position independent of the first printhead Z position.

11. The coating application system of claim 10, further comprising:
a controller in communication with the first adjustable support and with the second adjustable support, wherein the controller is configured to control an extension of the first adjustable support to adjust the first printhead Z position, the controller is configured to control an extension of the second adjustable support to adjust the second printhead Z position independent of the first printhead Z position, and wherein the controller is configured to maintain a print distance of from about 0.1 to about 3 centimeters for each of the first printhead and the second printhead, wherein the print distance is individually defined by a distance between each of the plurality of printheads and a substrate surface.

12. The coating application system of claim 1, wherein:
each of the plurality of printheads are configured to articulate independent of every other one of the plurality of printheads.

13. The coating application system of claim 12, wherein:
each of the plurality of printheads is connected to the traveling rod by an adjustable support such that the coating application system comprises a plurality of adjustable supports, and wherein a controller is in communication with each of the plurality of adjustable supports, wherein the controller is configured to adjust a Z position of each of the plurality of printheads independent of every other one of the plurality of printheads.

14. A method of coating a substrate, the method comprising the steps of:
positioning the substrate on a substrate support of a coating application system, wherein the substrate has a substrate maximum Y length and a substrate maximum X length, as determined by an XYZ coordinate system, and wherein the substrate further comprises a substrate surface;
supporting a plurality of printheads on a traveling rod, wherein the plurality of printheads comprise a first printhead and a second printhead, wherein each printhead comprises a high transfer efficiency applicator, wherein the first printhead and the second printhead are configured to articulate independent of each other, wherein the first printhead and the second printhead are at different Y positions on the traveling rod, and wherein the traveling rod has a traveling rod Y length that is greater than the substrate maximum Y length;
moving the traveling rod over the substrate such that the plurality of printheads pass over the entire substrate surface;
spraying a coating from the high transfer efficiency applicators onto the entire substrate surface as the traveling rod passes over the substrate surface; and
articulating the first printhead and the second printhead independent of each other as the coating is sprayed onto the substrate surface such that the first printhead is about perpendicular to the substrate surface and the second printhead is about perpendicular to the substrate surface as the coating is sprayed onto the substrate surface.

15. The method of coating the substrate of claim 14, wherein:
articulating the first printhead and the second printhead further comprises utilizing a controller to control the articulation of the first printhead and the second printhead, wherein the controller is in communication with the first printhead and the second printhead.

16. The method of coating the substrate of claim 14, wherein:
the plurality of printheads are configured to spray the coating along an entire length and an entire width of the substrate surface in a single pass.

17. The method of coating the substrate of claim 14, wherein:
each of the plurality of printheads are configured to articulate independent of every other one of the plurality of printheads.

18. The method of coating the substrate of claim 14, further comprising:
adjusting a first printhead Z position of the first printhead with a first adjustable support, wherein the first printhead is connected to the traveling rod through the first adjustable support, such that the first printhead is maintained at a print distance of from about 0.1 to about 3 centimeters from the substrate surface as the first printhead passes over the substrate surface; and
adjusting a second printhead Z position of the second printhead independent of the first printhead Z position, wherein the second printhead Z position is adjusted with a second adjustable support that connects the second printhead to the traveling rod, and wherein the second printhead is maintained at the print distance of from about 0.1 to about 3 centimeters from the substrate surface as the second printhead passes over the substrate surface.

19. The method of coating the substrate of claim 18, wherein the substrate is a motor vehicle body part.

20. A coating application system comprising:
a support system defined in an XYZ coordinate system, wherein the XYZ coordinate system comprises an X axis, a Y axis, and a Z axis that are all perpendicular to each other, wherein the X axis and the Y axis define an XY plane, wherein the XY plane is at a zero Z axis position, wherein the support system comprises a first bar and a second bar both running in an X direction in the XY plane;
a traveling rod connected to the first bar and the second bar, wherein the traveling rod is configured to travel in the X direction;
a plurality of printheads connected to the traveling rod, wherein the plurality of printheads comprises a first printhead and a second printhead;
a substrate support configured to support a substrate having a substrate maximum X length, a substrate maximum Y length, and a substrate surface, wherein the traveling rod has a traveling rod Y length that is greater than the substrate maximum Y length, the first bar has a first bar X length and the second bar has a second bar X length, wherein the first bar X length and the second bar X length are both greater than the substrate maximum X length;
a first adjustable support connecting the first printhead to the traveling rod, wherein the first adjustable support is configured to vary a first printhead Z position; and
a second adjustable support connecting the second printhead to the traveling rod, wherein the second adjustable support is configured to vary a second printhead Z position independent of the first printhead.
